(19) United States
(12) Patent Application Publication
(10) Pub. No.: US 2024/0136593 A1
(43) Pub. Date: Apr. 25, 2024

(54) SOLID-STATE SECONDARY BATTERY

(71) Applicant: HONDA MOTOR CO., LTD., Tokyo (JP)

(72) Inventors: Rio KOYAMA, Saitama (JP); Satoshi YONEZAWA, Saitama (JP); Masaki KUNIGAMI, Saitama (JP)

(21) Appl. No.: 18/363,755

(22) Filed: Aug. 1, 2023

(30) Foreign Application Priority Data
Aug. 7, 2022 (JP) 2022-126114

(51) Int. Cl. H01M 10/0585; H01M 4/36; H01M 4/62; H01M 10/0562

(52) U.S. Cl. CPC H01M 10/0585; H01M 4/366; H01M 4/62; H01M 10/0562; H01M 2004/028; H01M 2300/0068

(57) ABSTRACT

A solid-state secondary battery is provided which can suppress chemical degradation from charging/discharging. A solid-state secondary battery includes a laminate body made by a positive electrode layer, solid electrolyte layer and negative electrode layer being laminated, and a first solid electrolyte having oxidation resistance and a second solid electrolyte having reduction resistance, in which content of a first solid electrolyte is greater than a second solid electrolyte in a solid electrolyte contained in the positive electrode layer, content of the first solid electrolyte is greater than the second solid electrolyte in a solid electrolyte contained in a region on a side of the positive electrode layer of the solid electrolyte layer, and content of the second solid electrolyte is greater than content of the first solid electrolyte in a solid electrolyte contained in a region on a side of the negative electrode layer of the solid electrolyte layer.

This application is based on and claims the benefit of priority from Japanese Patent Application No. 2022-126114, filed on 8 Aug. 2022, the content of which is incorporated herein by reference.

### BACKGROUND OF THE INVENTION

### Field of the Invention

The present invention relates to a solid-state secondary battery.

### Related Art

In recent years, research and development related to secondary batteries that contribute to energy efficiency has been conducted in order to make it possible to ensure access to more people of affordable, reliable, sustainable and advanced energy. Among secondary batteries, the solid-state battery is superior in the point of the stability improving due to the solid electrolyte used as the conductor of charge transfer medium such as lithium ion being nonflammable, and the point of having higher energy density, and thus has received particular attention.

As a solid electrolyte, for example, a sulfide-based solid electrolyte having high lithium-ion conductivity has been known conventionally (for example, refer to Patent Document 1).
Patent Document 1: PCT International Publication No. WO2020/050269

### SUMMARY OF THE INVENTION

A solid-state secondary battery has a laminate body in which a positive electrode layer, solid electrolyte layer and negative electrode layer are laminated in this order. The solid electrolyte can be included not only in the solid electrolyte layer, but also in the positive electrode layer or negative electrode layer. In the conventional technology including the technology disclosed in Patent Document 1, it has been common for one type of solid electrolyte to be used. As a result thereof, as repeating charging/discharging of the solid-state secondary battery, there is a problem of the solid-state secondary battery deteriorating by the solid electrolyte being oxidized in the positive electrode layer or the solid electrolyte layer in the vicinity thereof, and the solid electrolyte being reduced in the negative electrode layer or the solid electrolyte layer in the vicinity thereof. Although it has been considered to use a solid electrolyte having a stable wide potential window for both the positive electrode and negative electrode, the current situation has been that such a solid electrolyte had not been conventionally known.

The present invention has been made taking account of the above, and has an object of providing a solid-state secondary battery which can suppress chemical degradation from charging/discharging.

A first aspect of the present invention relates to a solid-state secondary battery including a laminate body in which a positive electrode layer, a solid electrolyte layer and negative electrode layer are laminated; and a first solid electrolyte having oxidation resistance and a second solid electrolyte having reduction resistance, in which content of the first solid electrolyte in a solid electrolyte contained in the positive electrode layer is greater than the second solid electrolyte, content of the first solid electrolyte in a solid electrolyte contained in a region on a side of the positive electrode layer of the solid electrolyte layer is greater than the second solid electrolyte, and content of the second solid electrolyte in a solid electrolyte contained in a region on a side of the negative electrode layer of the solid electrolyte layer is greater than content of the first solid electrolyte.

According to the first aspect of the present invention, it is possible to provide a solid-state secondary battery which can suppress chemical degradation from charging/discharging.

According to a second aspect of the present invention, the solid-state secondary battery as described in the first aspect further includes a third solid electrolyte having ion conductivity equal to or greater than ion conductivity of the first solid electrolyte and equal to or greater than ion conductivity of the second solid electrolyte, in which content of the third solid electrolyte in a solid electrolyte contained in an intermediate region, which is a region between the region on the side of the positive electrode layer and the region on the side of the negative electrode layer of the solid electrolyte layer, is greater than other types of solid electrolyte.

According to the second aspect of the present invention, it is possible to suppress an increase in resistance of the solid-state secondary battery.

According to a third aspect of the present invention, the solid-state secondary battery as described in the second aspect further includes a fourth solid electrolyte having a melting point lower than the first solid electrolyte, the second solid electrolyte and the third solid electrolyte.

According to the third aspect of the present invention, it is possible to suppress an increase in resistance of the solid-state secondary battery, possible to decrease confining pressure, and suppress precipitation of dendrite.

According to a fourth aspect of the present invention, in the solid-state secondary battery as described in any one of the first to third aspects, the positive electrode layer has a positive electrode active material, and a surface of the positive electrode active material is covered by a solid electrolyte containing at least 50% by mass of the first solid electrolyte.

According to the fourth aspect of the present invention, it is possible to suppress the solid electrolyte present on the surface of the positive electrode active material from being oxidized and resistance rising.

In addition, a fifth aspect of the present invention relates to a method of manufacturing a solid-state secondary battery having a laminate body in which a positive electrode layer, a solid electrolyte layer and a negative electrode layer are laminated, the method including: a step of forming the positive electrode layer using a material containing a first solid electrolyte having oxidation resistance; and a step of forming the solid electrolyte layer using a material containing the first solid electrolyte and a second solid electrolyte having reduction resistance, in which the step of forming the solid electrolyte layer forms the solid electrolyte layer so that content of the first solid electrolyte is greater than the second solid electrolyte in a solid electrolyte contained in a region on a side of the positive electrode layer of the solid electrolyte layer, and content of the second solid electrolyte is greater than content of the first solid electrolyte in a solid electrolyte contained in a region on a side of the negative electrode layer of the solid electrolyte layer.

According to the fifth aspect of the present invention, it is possible to manufacture a solid-state secondary battery which can suppress chemical degradation from charging/discharging.

According to a sixth aspect of the present invention, in the method of manufacturing the solid-state secondary battery as described in the fifth aspect, the step of forming the solid electrolyte layer includes: a step of forming a layer of part of the solid electrolyte layer using a material containing more of the first solid electrolyte than the second solid electrolyte on a side of the positive electrode layer; and a step of forming a layer of part of the solid electrolyte layer using a material containing more of the second solid electrolyte than the first solid electrolyte on a side of the negative electrode layer.

According to the sixth aspect of the present invention, it is possible to preferably manufacture a solid-state secondary battery which can suppress chemical degradation from charging/discharging.

According to a seventh aspect of the present invention, in the method of manufacturing the solid-state secondary battery as described in the fifth or sixth aspect, the step of forming the solid electrolyte layer further includes: a step of forming the solid electrolyte layer using a material containing a third solid electrolyte having ion conductivity equal to or greater than ion conductivity of the first solid electrolyte, and equal to or greater than ion conductivity of the second solid electrolyte, and forming a layer of part of the solid electrolyte layer using a material containing more of the third solid electrolyte than other types of solid electrolyte, in an intermediate region, which is a region between the region on the side of the positive electrode layer and the region on the side of the negative electrode layer of the solid electrolyte layer.

According to the seventh aspect of the present invention, it is possible to manufacture a solid-state secondary battery in which an increase in resistance is suppressed.

According to an eighth aspect of the present invention, in the method of manufacturing the solid-state secondary battery as described in the seventh aspect, at least any of the step of forming the positive electrode layer and the step of forming the solid electrolyte layer forms each layer using a material containing a fourth solid electrolyte having a lower melting point than all of the first solid electrolyte, the second solid electrolyte and the third solid electrolyte, and in which the method further includes a heat treatment step of melting the fourth solid electrolyte by heating after the fourth solid electrolyte has been disposed.

According to the eighth aspect of the present invention, it is possible to manufacture a solid-state secondary battery in which an increase in resistance of the solid-state secondary battery is suppressed, which can decrease the confining pressure, and in which precipitation of dendrite is suppressed.

### BRIEF DESCRIPTION OF THE DRAWINGS

FIG. 1 is a cross-sectional schematic view showing the configuration of a laminate body of a solid-state secondary battery according to an embodiment of the present invention;

FIG. 2 is the XRD spectra of the sulfide-based solid electrolytes related to the Examples and Comparative Examples;

FIG. 3 is a graph showing charge/discharge test results of a sulfide-based solid electrolyte according to Examples;

FIG. 4 is a graph showing a relationship between a heat treatment time and ionic conductivity of a sulfide-based solid electrolyte according to Examples;

FIG. 5 is a graph showing a relationship between a heat treatment time and ion conductivity of a sulfide-based solid electrolyte according to Examples;

FIG. 6 provides LSV measurement results of sulfide-based solid electrolytes related to the Examples and Comparative Examples; and

FIG. 7 is a graph of durability test results of a sulfide-based solid electrolyte according to Examples.

### DETAILED DESCRIPTION OF THE INVENTION

### <Solid-State Secondary Battery>

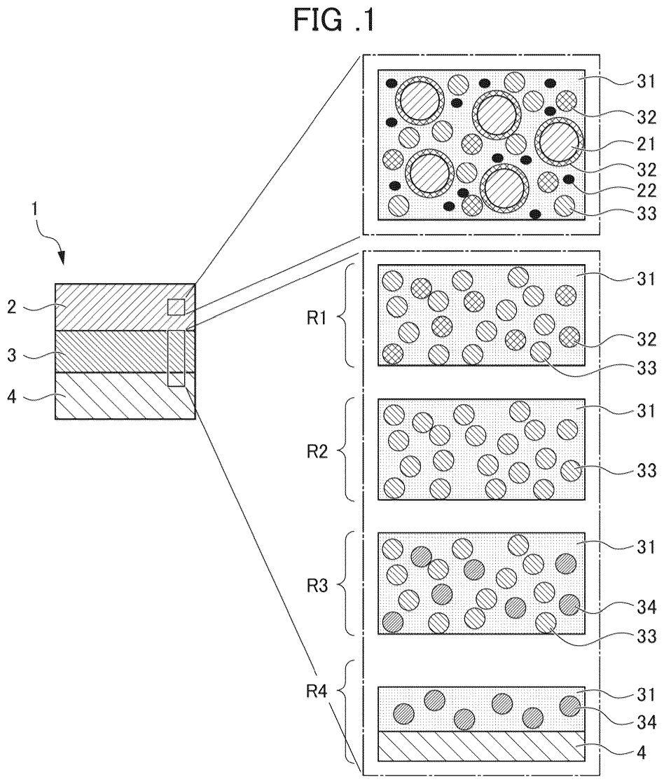

A solid-state secondary battery according to the present embodiment has a laminate body 1 in which a positive electrode layer 2, solid electrolyte layer 3, and negative electrode layer 4 are laminated in this order, as shown in FIG. 1. The solid electrolyte can be included in either of the above layers of the laminate body 1. In the solid-state secondary battery according to the present embodiment, a first solid electrolyte having oxidation resistance is relatively abundantly contained in the positive electrode layer 2 and the solid electrolyte layer 3 on the side of the positive electrode layer 2, and a second solid electrolyte having reduction resistance is relatively abundantly contained in the solid electrolyte layer 3 on the side of the negative electrode layer 4. It is thereby possible to suppress chemical degradation due to charging/discharging of the solid-state secondary battery.

(Solid Electrolyte)

The solid-state secondary battery according to the present embodiment has a first solid electrolyte 32 having oxidation resistance, and a second solid electrolyte 34 having reduction resistance. Other than the above, the solid-state secondary battery may further have at least any of a third solid electrolyte 33 and fourth solid electrolyte 31.

The first solid electrolyte 32 is a stable solid electrolyte which is hardly oxidized in the high-potential positive electrode. As specific examples of the first solid electrolyte 32, for example, chlorides such as Li₂ZrCl₆ and oxides such as LLZO (Li₇La₃Zr₂O₁₂) can be exemplified.

The second solid electrolyte 34 is a stable solid electrolyte which is hardly reduced in the low-potential negative electrode. As specific examples of the second solid electrolyte 34, for example, hydrides such as LiBH₄, LiBH₄—LiNH₂, and oxides such as LIPON can be exemplified.

As at least any of the first solid electrolyte 32 and second solid electrolyte 34, a sulfide-based solid electrolyte may be used in which a chemical bond is formed between Li₂S—P₂S₅ and LiBH₄, and the mole ratio of Li₂S—P₂S₅ and LiBH₄ is 1:0.5. This is because the above-mentioned sulfide-based solid electrolyte has superior reduction resistance and oxidation resistance. In other words, both of the first solid electrolyte 32 and second solid electrolyte 34 may be established as a common solid electrolyte as the above-mentioned sulfide-based solid electrolyte.

The third solid electrolyte 33 is a solid electrolyte having higher ion conductivity than the first solid electrolyte 32 and second solid electrolyte 34. As specific examples of the third solid electrolyte 33, for example, LPS-based-LiX sulfide-based solid electrolyte such as Li₂S—P₂S₅—LiX (X: halogen) can be exemplified. It should be noted that the above description of “Li₂S—P₂S₅” indicates a sulfide-based electrolyte material made using a raw material composition containing Li₂S and P₂S₅.

The fourth solid electrolyte 31 has a lower melting point than all of the first solid electrolyte 32, second solid electrolyte 34 and the third solid electrolyte 33. As a specific example of the fourth solid electrolyte 31, for example, LiBH₄—LiNH₂ can be exemplified. It should be noted that the mole ratio of LiBH₄ and LiNH₂ can be arbitrarily set. By cooling and solidifying the fourth solid electrolyte 31 after melting, the particles of the fourth solid electrolyte 31 function as a binding material by being filled and arranged between other particles. For this reason, by using the fourth solid electrolyte 31 in place of an organic binder, it is possible not only to suppress an increase in resistance, but also possible to maintain the cell characteristics of the solid-state secondary battery even in the case of reducing the confining pressure for maintaining adhesion. Therefore, it is possible to decrease the installation space and production cost of elements which increase the confining pressure on the solid-state secondary battery. In addition, in the case of using lithium metal as the negative electrode layer 4, due to being able to form a uniform boundary between the solid electrolyte layer 3 and negative electrode layer 4 by the fourth solid electrolyte 31, it is possible to suppress precipitation of dendrite.

(Positive Electrode Layer)

The positive electrode layer 2 is a layer having a positive electrode collector, positive electrode active material layer which at least contains positive electrode active material 21, and the solid electrolyte. It should be noted that the positive electrode collector is omitted from illustration in FIG. 1.

The positive electrode collector is not particularly limited so long as having a function of performing current collection of the positive electrode layer, and can be exemplified by aluminum, aluminum alloy, stainless steel, nickel, silver, titanium or the like, for example, and thereamong, aluminum, aluminum alloy and stainless steel are preferred. In addition, the shape of the positive electrode collector, for example, can be exemplified by foil, plate or the like.

The positive electrode active material 21 can employ the same material as that used in the positive electrode layer of a general solid-state battery, and is not particularly limited. For example, so long as a lithium ion battery, it is possible to exemplify a film-like active material containing lithium, spinel-type active material, olivine-type active material or the like. As specific examples of the positive electrode active material 21, lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium magnesium oxide (LiMn₂O₄), a different kind element substituted li—Mn spinel represented by Li₁₊ₓMn_{2-x-y}M_{y}O₄ (x+y=2, M=at least one type selected from Al, Mg, Co, Fe, Ni and Zn), lithium titanate (oxide containing Li and Ti), lithium metal phosphate (LiMPO₄, M=at least one type selected from Fe, Mn, Co and Ni), etc. can be exemplified.

In the solid electrolyte of the positive electrode layer 2, the content of first solid electrolyte 32 is greater than the second solid electrolyte 34. In the present embodiment, in the solid electrolyte of the positive electrode layer 2, it is preferable for the content of the first solid electrolyte 32 to be 5 to 55% by mass, the content of the third solid electrolyte 33 to be 40 to 85% by mass, and the content of the fourth solid electrolyte 31 to be 5 to 10% by mass.

The surface of the positive electrode active material 21 is preferably covered by the solid electrolyte containing at least 50% by mass of the first solid electrolyte 32. It is thereby possible to suppress the solid electrolyte present on the surface of the positive electrode active material 21 from being oxidized and the resistance rising. In the solid electrolyte covering the surface of the positive electrode active material 21, it is preferable for the content of the first solid electrolyte 32 to be 50 to 100% by mass, and the content of the third solid electrolyte 33 to be 0 to 50% by mass. As the method of covering the surface of the above-mentioned positive electrode active material 21 with the solid electrolyte, a method which compounds the positive electrode active material 21 and solid electrolyte by applying a strong shear force by a mixer or the like mixing the positive electrode active material 21 and solid electrolyte, for example, can be exemplified. According to the above method, it can be considered that the positive electrode active material 21 having a large difference in particle size and the solid electrolyte bind by intermolecular force, whereby compounding occurs.

Other than the above, the positive electrode layer 2 may include any conductive additive agent 22 to improve conductivity. Furthermore, any binder may be included from the viewpoint of improving the binding force between particles and coating characteristic. On the other hand, in the positive electrode layer 2 of the present embodiment, it is preferable for the positive electrode layer 2 not to include a binder due to the fourth solid electrolyte 31 being contained therein. The conductive additive agent 22 and binder which can be included in the positive electrode layer 2 are not particularly limited, and it is possible to use those which are generally used in solid-state batteries.

(Solid Electrolyte Layer)

The solid electrolyte layer 3 is a layer laminated between the positive electrode layer and negative electrode layer, and is a layer containing at least the solid electrolyte. Via the solid electrolyte included in the solid electrolyte 3, it is possible to perform charge transfer medium conduction between the positive electrode active material and negative electrode active material.

The solid electrolyte layer 3 has a plurality of regions in which the ratio of solid electrolyte included in the solid electrolyte layer 3 respectively differ. In the present embodiment, the solid electrolyte layer 3 includes a region R1 on the side of the positive electrode layer 2, regions R3 and R4 on the side of the negative electrode layer 4, and an intermediate region R2. It should be noted that the region R4 is a region adjacent to the negative electrode layer 4, and the region R3 is a region adjacent to the region R4.

In the solid electrolyte contained in region R1 on the side of the positive electrode layer 2, it is preferable for the content of the first solid electrolyte 32 to be 5 to 55% by mass, the content of the third solid electrolyte 33 to be 40 to 85% by mass, and the content of the fourth solid electrolyte 31 to be 5 to 10% by mass.

In the solid electrolyte contained in the intermediate region R2, it is preferable for the content of the third solid electrolyte 33 to be 90 to 99% by mass, and the content of the fourth solid electrolyte 31 to be 1 to 10% by mass.

In the solid electrolyte contained in the region R3 on the side of the negative electrode layer 4, it is preferable for the content of the second solid electrolyte 34 to be 5 to 55% by mass, the content of the third solid electrolyte 33 to be 40 to 85% by mass, and the content of the fourth solid electrolyte 31 to be 5 to 10% by mass.

In the solid electrolyte contained in the region R4 on the side of the negative electrode layer 4, it is preferable for the content of the second solid electrolyte 34 to be 0 to 95% by mass, and the content of the fourth solid electrolyte 31 to be 5 to 100% by mass.

By establishing the solid electrolyte layer 3 as the above-mentioned composition, it is possible to suppress chemical degradation from charging/discharging of the solid-state secondary battery, and suppress an increase in resistance, and possible to decrease the confining pressure of the solid-state secondary battery. In addition, in the case of using lithium metal as the negative electrode layer 4 of the solid-state secondary battery, it is possible to suppress precipitation of dendrite.

(Negative Electrode Layer)

The negative electrode layer 4 is a layer having a negative electrode collector, negative electrode active material layer at least containing the negative electrode active material, and the solid electrolyte.

As the negative electrode active material contained in the negative electrode active material layer, it is possible to appropriately select and use a known material which can store and release, or dissolve and precipitate the charge transfer medium such as lithium ion or sodium ion. For example, a lithium transition metal oxide such as lithium titanate, transition metal oxide such as TiO₂, Nb₂O₃ and WO₃, Si, SiO, metal sulfides, metal nitrides, and carbon materials such as artificial graphite, natural graphite, graphite, soft carbon and hard carbon, and lithium metal, indium metal and lithium alloy can be exemplified. As the negative electrode active material layer, one having a lithium metal layer is preferred.

The negative electrode active material layer may include any solid electrolyte such as the second solid electrolyte 34 and fourth solid electrolyte 31 from the viewpoint of improving the charge transfer medium conductivity. The negative electrode active material layer may include binder; however, it is preferable not to include binder.

### <Method of Manufacturing Solid-state Secondary Battery>

The method of manufacturing a solid-state secondary battery according to the present embodiment is manufactured by laminating in this order the positive electrode layer 2, solid electrolyte layer 3 and negative electrode layer 4. It should be noted that it may be optionally integrated by pressing after the above-mentioned laminating. Further, a plurality of the above-mentioned constituent units may be laminated as a unit battery.

The step of forming the positive electrode layer 2 and negative electrode layer 4, for example, may be a step of coating a positive electrode mixed slurry containing the components constituting the above-mentioned positive electrode active material layer onto the positive electrode collector. The means for coating is not particularly limited, and in addition to being able to use an ink jet method, a screen printing method, sputtering method or the like, a well-known coating means such as a doctor blade or dipping may be used. In the case of using lithium metal as the negative electrode active material layer of the negative electrode layer 4, the lithium metal and negative electrode collector may be joined by clad material or the like.

The step of forming the solid electrolyte layer 3, for example, may include a step of separately preparing a solid electrolyte slurry forming a layer of a part of the solid electrolyte layer 3 arranged on the side of the positive electrode layer 2, a solid electrolyte slurry forming a layer of a part of the solid electrolyte layer 3 arranged on the side of the negative electrode layer 4, and a solid electrolyte slurry forming a layer of a part of the solid electrolyte layer 3 arranged in an intermediate region, which is a region between the region on the side of the positive electrode layer 2 and a region on the side of the negative electrode layer 4; and a step of forming a layer of part of the solid electrolyte layer sequentially using the above prepared solid electrolyte slurries. The ratios of the solid electrolyte included in the solid electrolyte layer arranged in each of the above regions are as mentioned above.

The step of sequentially forming layers of part of the above-mentioned solid electrolyte layer may be a step of separately creating layers of part of each solid electrolyte layer and laminating, or may be a step of coating the solid electrolyte slurries sequentially on the positive electrode layer 2 or the negative electrode layer 4. The means for coating the solid electrolyte slurries can employ the same means as the means for coating the above-mentioned positive electrode mixed slurry.

In the case of forming the positive electrode layer 2 and solid electrolyte layer 3 using the fourth solid electrolyte 31, it is preferable to include a heat treatment step of melting the fourth solid electrolyte 31 by heating each layer after the above-mentioned coating step. It is possible to fill and arrange the particles of the fourth solid electrolyte 31 between other particles, by the fourth solid electrolyte 31 melting by the heat treatment step, and subsequently cooling to solidify.

Although a preferred embodiment of the present invention has been explained above, the present invention is not to be limited to the above-mentioned embodiment, and modifications and improvements within a scope that can achieve the object of the present invention are encompassed by the present invention.

### EXAMPLES

Hereinafter, a sulfide-based solid electrolyte in which chemical bonds are formed between Li₂S—P₂S₅ and LiBH₄, and the mole ratio of Li₂S—P₂S₅ and LiBH₄ is 1:0.5, which can be used as the first solid electrolyte and second solid electrolyte of the present invention will be explained in detail using the Examples. However, the present invention is not limited to these Examples.

### Preparation of Sulfide-based Solid Electrolyte

### Example 1

So that the mole ratio of Li₂S, P₂S₅ and LiBH₄ as raw materials of the sulfide-based solid electrolyte becomes 3:1:2, they are blended, stirred with 20 ml of THF as a solvent using a flask mixer (30 rpm, 25° C.) to make a uniform dispersed/dissolved state. Next, the solvent was removed by heating in a mantle heater while stirring (30 rpm, 150° C.) After solvent removal, the sulfide-based electrolyte according to Example 1 was prepared by heat treating (100° C.) in a vacuum electric furnace.

### Comparative Examples 1 and 2

Except for establishing the mole ratio of Li₂S, P₂S₅ and LiBH₄ as the ratio shown in Table 1, the sulfide-based solid electrolytes according to Comparative Examples 1 and 2 were prepared similarly to Example 1.

TABLE 1

| Examples/ | | | | Blending ratio | Solvent | Heating |
|---|---|---|---|---|---|---|
| Comparative Examples | Blending amount (g) | | | (mol ratio) | amount | temperature |
| (sample name) | Li₂S | P₂S₅ | LiBH₄ | Li₂S:P₂S₅:LiBH₄ | (mL) | (° C.) |
| Comparative Example1 | 0.1035 | 0.3269 | 0.0706 | 6:2:9 | 20 | 100 |
| (LPS-1.5LiBH₄) | | | | | | |
| Comparative Example2 | 0.1061 | 0.34 | 0.047 | 3:1:3 | 20 | 100 |
| (LPS-LiBH₄) | | | | | | |
| Example1 (LPS-0.5LiBH₄) | 0.1007 | 0.329 | 0.024 | 6:2:3 | 20 | 100 |

(XRD Measurement)

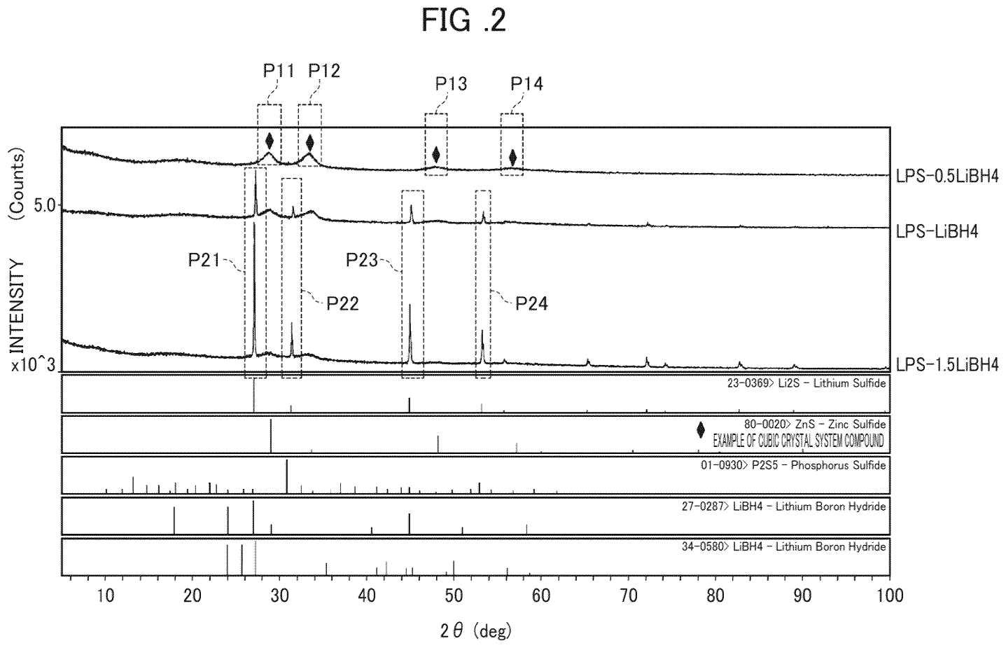

The crystalline structure of the sulfide-based solid electrolytes according to the above Examples and Comparative Examples were analyzed using XRD (“D8 Advance” manufactured by Bruker AXS, X-ray source). The obtained XRD spectra are shown in FIG. 2.

As shown in FIG. 2, in the sulfide-based solid electrolytes according to Comparative Examples 1 and 2, peaks attributed to the source materials (P21 to P24) are recognized. On the other hand, in the sulfide-based solid electrolyte according to Example 1, the peaks attributed to the above-mentioned source materials disappear, and unknown peaks (P11 to P14) which do not exist in the XRD database were newly recognized in the vicinity of 2θ[deg]=29, 33, 48 and 57, respectively. A new crystalline structure was thereby confirmed, and chemical bonds are presumed to form between Li₂S—P₂S₅ and LiBH₄.

(Charge/Discharge Test)

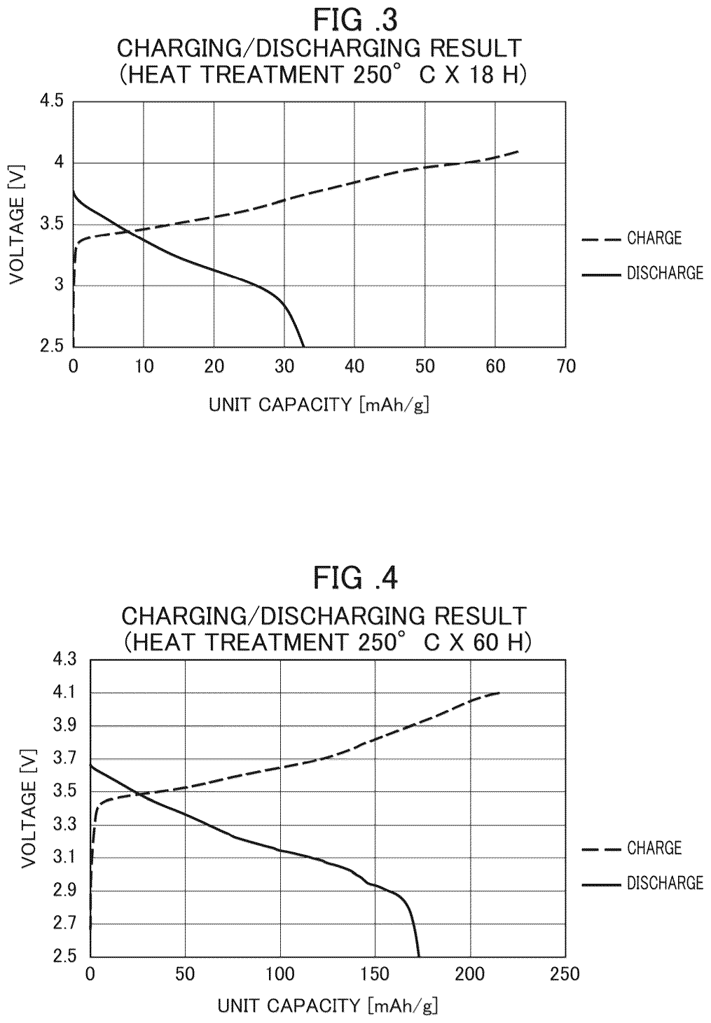

Using the sulfide-based solid electrolyte made by growing crystals with the heat treatment conditions of the sulfide-based solid electrolyte according to Example 1 of 250° C. and 18 hours as the solid electrolyte layer, the positive electrode layer was prepared with the positive electrode active material as NCM811 (LiNi_{0.8}Co_{0.1}Mn_{0.1}O₂), the solid-state battery cell was prepared with lithium-aluminum alloy as the negative electrode layer, and charge/discharge test was performed. The results are shown in FIG. 3. In addition, a solid-state battery cell was prepared similarly to above using the sulfide-based solid electrolyte made by growing crystals with the heat treatment conditions of 250° C. and 60 hours

The results are shown in FIG. 4.

As shown in FIG. 3 and FIG. 4, in the solid-state secondary battery made using the sulfide-based solid electrolyte according to the present embodiment, it was confirmed that charge/discharge can be performed. In addition, by increasing the heat treatment time, it was confirmed that the theoretical capacity increased.

(Ion Conductivity Measurement)

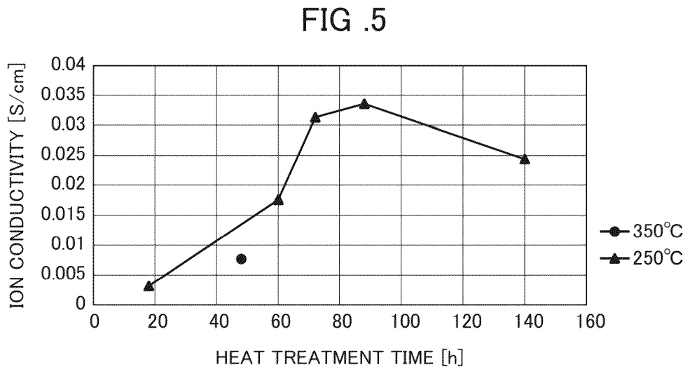

FIG. 5 is the measurement results of ion conductivity in the case of varying the heat treatment conditions of the sulfide-based solid electrolyte according to Example 1. AC impedance measurement was performed on a single solid electrolyte according to Example 1, and the ion conductivity was calculated from the obtained resistance value. From the results of FIG. 5, the result was confirmed in which the ion conductivity reaches a maximum in the case of setting the heat treatment temperature of 250° C. and heat treatment time of 88 hours.

(LSV Measurement)

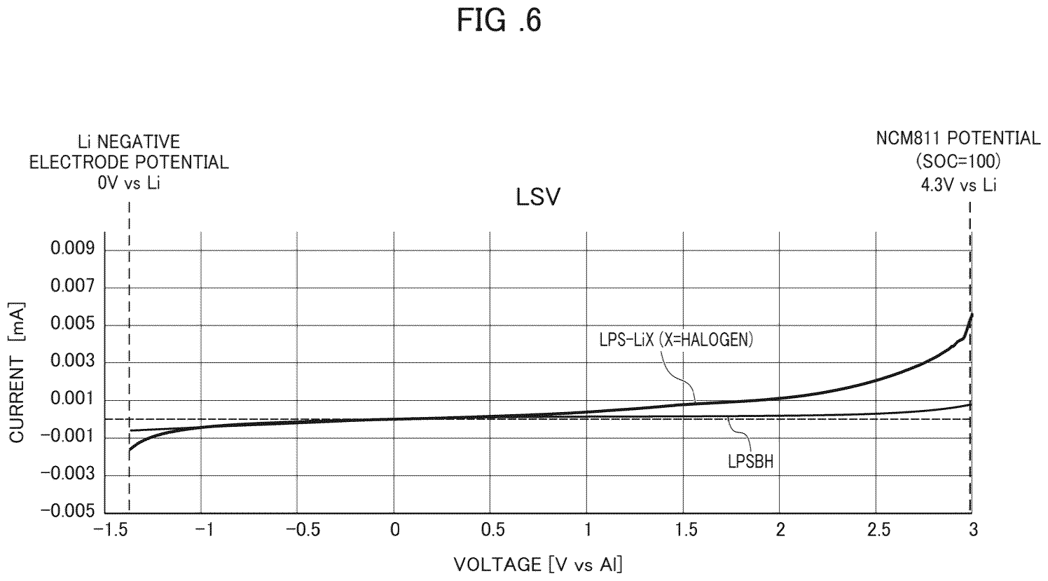

FIG. 6 is a graph showing the LSV measurement results of the solid-state secondary battery (LPSBH in FIG. 6) using the sulfide-based solid electrolyte according to Example 1 as the solid electrolyte layer, preparing the positive electrode layer with the positive electrode active material as NCM811, and prepared using lithium metal as the negative electrode layer. The LSV measurement conditions of FIG. 6 were swept at 5 mV/s from the standard potential at full charge of NCM811 until the standard potential of the lithium metal. In addition, except for using a commercially available sulfide-based solid electrolyte (LPS-LiX, X: halogen in FIG. 6), the solid-state secondary battery was prepared similarly to the above, and LSV measurement was performed at the same conditions as above. In the graph of FIG. 6, the horizontal axis indicates the potential (V), and the vertical axis indicates the current (mA).

As shown in FIG. 6, the solid-state secondary battery made using the sulfide-based solid electrolyte according to Example 1 caused almost no oxidation reaction and reduction reaction compared to the solid-state secondary battery made using the conventional sulfide-based solid electrolyte, and results superior in oxidation resistance and reduction resistance were confirmed.

(Resistance Deterioration Measurement)

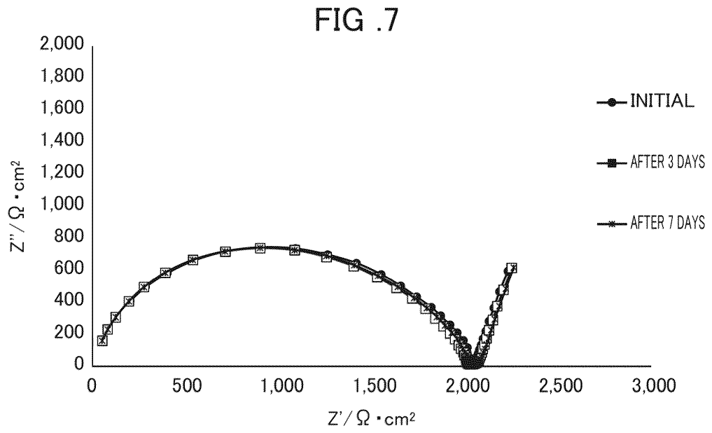

The solid-state secondary battery was prepared using the solid electrolyte shown in FIG. 6, and the resistance value was measured by the AC impedance method. Subsequently, after leaving for 3 days and 7 days, respectively in a state of full charge, the resistance value was measured by AC impedance method similarly. The results are shown in FIG. 7. As shown in FIG. 7, in the solid-state secondary battery produced using the sulfide-based solid electrode according to Example 1 the resistance value did not increase even after leaving for 7 days at full charge, and results in which preferable durability is obtained was confirmed. In contrast, when the resistance value was measured by the AC impedance method similarly using the conventional argyrodite-type sulfide-based solid electrolyte, the results were confirmed in which the resistance value after leaving for 7 days at full charge increased 12 times relative to the initial resistance value, and the resistance value after leaving for 14 days at full charge increased 23 times relative to the initial resistance value.

### EXPLANATION OF REFERENCE NUMERALS

1 laminate body
2 positive electrode layer
3 solid electrolyte layer
31 fourth solid electrolyte
32 first solid electrolyte
33 third solid electrolyte
34 second solid electrolyte
4 negative electrode layer
R1 positive electrode layer-side region
R2 intermediate region
R3, R4 negative electrode layer-side region

What is claimed is:

1. A solid-state secondary battery comprising a laminate body in which a positive electrode layer, a solid electrolyte layer and negative electrode layer are laminated; and
a first solid electrolyte having oxidation resistance and a second solid electrolyte having reduction resistance,
wherein content of the first solid electrolyte in a solid electrolyte contained in the positive electrode layer is greater than the second solid electrolyte,
wherein content of the first solid electrolyte in a solid electrolyte contained in a region on a side of the positive electrode layer of the solid electrolyte layer is greater than the second solid electrolyte, and
wherein content of the second solid electrolyte in a solid electrolyte contained in a region on a side of the negative electrode layer of the solid electrolyte layer is greater than content of the first solid electrolyte.

2. The solid-state secondary battery according to claim 1, further comprising a third solid electrolyte having ion conductivity equal to or greater than ion conductivity of the first solid electrolyte and equal to or greater than ion conductivity of the second solid electrolyte,
wherein content of the third solid electrolyte in a solid electrolyte contained in an intermediate region, which is a region between the region on the side of the positive electrode layer and the region on the side of the negative electrode layer of the solid electrolyte layer, is greater than other types of solid electrolyte.

3. The solid-state secondary battery according to claim 2, further comprising a fourth solid electrolyte having a melting point lower than the first solid electrolyte, the second solid electrolyte and the third solid electrolyte.

4. The solid-state secondary battery according to claim 1, wherein the positive electrode layer has a positive electrode active material, and
wherein a surface of the positive electrode active material is covered by a solid electrolyte containing at least 50% by mass of the first solid electrolyte.

5. A method of manufacturing a solid-state secondary battery having a laminate body in which a positive electrode layer, a solid electrolyte layer and a negative electrode layer are laminated, the method comprising:
a step of forming the positive electrode layer using a material containing a first solid electrolyte having oxidation resistance; and
a step of forming the solid electrolyte layer using a material containing the first solid electrolyte and a second solid electrolyte having reduction resistance,
wherein the step of forming the solid electrolyte layer forms the solid electrolyte layer so that content of the first solid electrolyte is greater than the second solid electrolyte in a solid electrolyte contained in a region on a side of the positive electrode layer of the solid electrolyte layer, and content of the second solid electrolyte is greater than content of the first solid electrolyte in a solid electrolyte contained in a region on a side of the negative electrode layer of the solid electrolyte layer.

6. The method of manufacturing a solid-state secondary battery according to claim 5, wherein the step of forming the solid electrolyte layer includes:
a step of forming a layer of part of the solid electrolyte layer using a material containing more of the first solid electrolyte than the second solid electrolyte on a side of the positive electrode layer; and
a step of forming a layer of part of the solid electrolyte layer using a material containing more of the second solid electrolyte than the first solid electrolyte on a side of the negative electrode layer.

7. The method of manufacturing a solid-state secondary battery according to claim 5, wherein the step of forming the solid electrolyte layer further includes:
a step of forming the solid electrolyte layer using a material containing a third solid electrolyte having ion conductivity equal to or greater than ion conductivity of the first solid electrolyte, and equal to or greater than ion conductivity of the second solid electrolyte, and
forming a layer of part of the solid electrolyte layer using a material containing more of the third solid electrolyte than other types of solid electrolyte, in an intermediate region, which is a region between the region on the side of the positive electrode layer and the region on the side of the negative electrode layer of the solid electrolyte layer.

8. The method of manufacturing a solid-state secondary battery according to claim 7, wherein at least any of the step of forming the positive electrode layer and the step of forming the solid electrolyte layer forms each layer using a material containing a fourth solid electrolyte having a lower melting point than all of the first solid electrolyte, the second solid electrolyte and the third solid electrolyte, and
wherein the method further comprises a heat treatment step of melting the fourth solid electrolyte by heating after the fourth solid electrolyte has been disposed.
